(19) United States
(12) Patent Application Publication
(10) Pub. No.: US 2013/0115034 A1
(43) Pub. Date: May 9, 2013

(54) PIN POSITION SENSOR MOUNTING ASSEMBLY

(71) Applicant: Michael C. Subrt, Chillicothe, IL (US)

(72) Inventor: Michael C. Subrt, Chillicothe, IL (US)

(73) Assignee: Caterpillar Inc., Peoria, IL (US)

(21) Appl. No.: 13/291,443

(22) Filed: Nov. 8, 2011

(51) Int. Cl. E02F 3/36; G01N 19/00; E02F 9/14

(52) U.S. Cl. 414/685; 414/722; 73/865.8

(57) ABSTRACT

A sensor assembly is disclosed for a pin connection of a machine linkage, such as that found on an excavator or backhoe loader, the sensor assembly including a sensor associated with a sensor housing that receives the pin, and a connector assembly that connects the sensor housing to a frame element, wherein the connector assembly is configured to allow the sensor housing to move relative to the frame element. The sensor assembly may be positioned within one of the members of the linkage.

### TECHNICAL FIELD

This invention relates to an assembly for a pin sensor that can be employed to accurately determine the position of a linkage member of a machine such as an excavator or loader. More specifically, the invention relates to an assembly that includes a sensor housing disposed about a pin wherein the housing is connected to a linkage member through a movable connection that reduces the effects of pin slop.

### BACKGROUND

Various types of digging machinery, such as excavators, shovels, backhoes, and wheeled or tracked loaders may include a linkage connected at a first end to the main body or frame of the machine, and a work implement, such as a bucket, located at a distal end thereof. The separate components of the linkage may be coupled by pin connections formed by positioning a pin within aligned holes in adjacent components of the linkage. The pin connections allow the adjacent components of the linkage to pivot with respect to one another during digging operations.

Some machines have been equipped with computer systems capable of computing the position of the implement or specific components of the linkage during operation based on information received from sensors associated therewith. For example, position sensors may be associated with hydraulic actuators or the pin connections that are in electrical connection with the controller, which then calculates the position of one or more components of the linkage based on known machine dimensions. Other purposes for such pin sensors are known in the art.

U.S. Pat. No. 6,564,480 describes a pin angle sensor assembly that includes a pin having a recess at an end thereof. The angle sensor comprises a case that is disposed within the recess. An input shaft of the sensor extends out from an end of the pin, which is then connected via a lever to an arm of the machine. The rotating angle of the input shaft is detected by the sensor unit, and the relative angle of the arm is obtained based on the detected value. The position of the sensor unit to the side of the pin and arm is stated to protect the sensor from coming into contact with soil and the like. Additionally, an external cover may be provided that is attached over the sensor for added protection.

### SUMMARY OF THE INVENTION

In one aspect this disclosure describes a sensor assembly for a pin of a machine linkage, the sensor assembly including a sensor housing having an open end for receiving at least a portion of the pin, and a sensor associated with the housing, and a connector assembly connecting the sensor to a frame element such that the connector assembly allows the sensor housing to move relative to the frame element.

In another aspect, provided is a machine having a linkage with a plurality of linkage members and a work implement coupled to a first end of the linkage, the linkage including a pin connection with a pin sensor assembly. The sensor assembly includes a sensor housing having an open end for receiving at least a portion of the pin, a sensor associated with the housing, and a connector assembly connecting the sensor to a frame element such that the connector assembly allows the sensor housing to move relative to the frame element.

In yet another aspect, provided is a machine linkage including a first member and a second member, each member having an end with at least two spaced openings, a pin disposed within the aligned openings of the first and second member, the first member including an internal cavity, and a pin sensor assembly disposed within the internal cavity. The sensor assembly includes a housing with a first and second end, the pin being disposed through the first and second ends, and the housing disposed between the spaced openings of the first and second member. A sensor is associated with the housing and configured to provide a signal indicative of rotation of the pin. A connector assembly connects the sensor housing to the first linkage member to allow the sensor housing to move relative thereto.

These and other aspects and advantages of the present disclosure will become apparent to those skilled in the art upon reading the following detailed description in connection with the drawings and appended claims.

### BRIEF DESCRIPTION OF THE DRAWINGS

FIG. 1 is a side view of an excavator having a linkage and implement in accordance with an exemplary embodiment of the present disclosure;

FIG. 2 is an enlarged portion of a region of the excavator linkage of FIG. 1 surrounding one of the pin connections of the linkage, in cross-section, and showing an exemplary pin angle sensor assembly of the present disclosure;

FIG. 3 is a cross-sectional view of an exemplary angle sensor housing and associated pin;

FIG. 4 is a side view of another exemplary embodiment of a pin angle sensor assembly;

FIG. 5 is a side view of another exemplary embodiment of a pin angle sensor assembly;

FIG. 6 is a side view of another exemplary embodiment of a pin angle sensor assembly.

### DETAILED DESCRIPTION

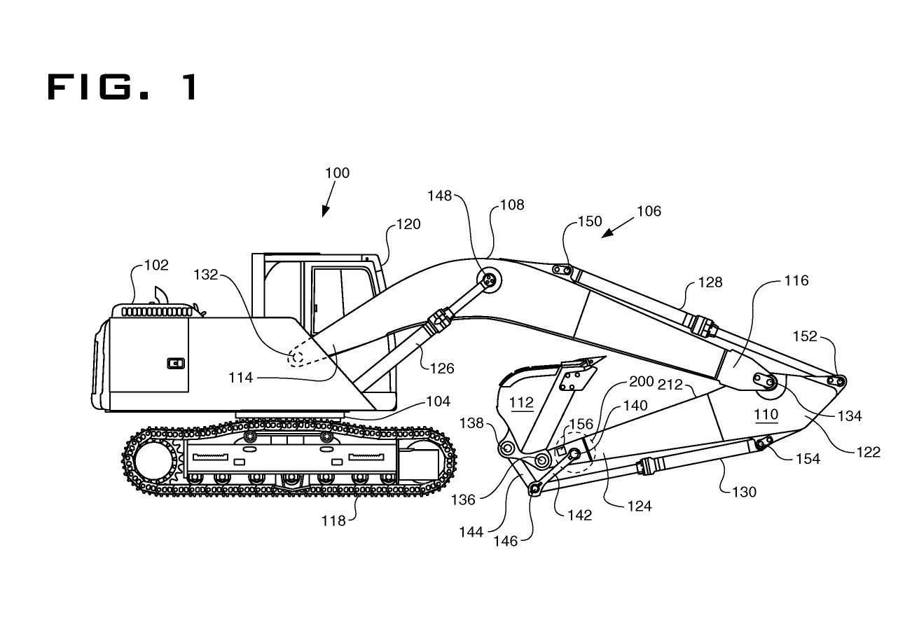

FIG. 1 shows an exemplary machine 100, an excavator, having a body 102 mounted on an undercarriage 104. The body 102 is configured for rotation relative to the undercarriage 104, typically via a ring gear (not shown). Supporting the undercarriage 104 are traction devices, tracks 118. An operator station 120 is connected to the body 102 and typically contains interactive devices, joysticks, pedals, steering wheels, and the like, for primary control of the various machine systems, propulsion, steering, braking, hydraulics, etc., during typical machine operations.

Although in this exemplary embodiment the machine 100 is an excavator, the machine 100 could be one of many different types of industrial machinery that require a linkage 106, such as a backhoe loader, wheel or tracked loader, material handler, forestry machine (feller buncher, forwarder, harvester or the like), crane or any other of numerous types of machines used in various industries such as mining, construction, forestry, waste management, and the like.

The machine includes a linkage 106 having mating components that generally include a boom 108, stick 110, and implement 112. The boom 108 includes a first end 114 and a second, distal end 116, the first end 114 being pivotally connected for vertical movement relative to machine body 102 at pin connection 132. Similarly, the boom 108 is connected to a stick 110 at a first end 122 thereof via pin connection 134. The second end 124 of the stick 110 is pivotally connected to the work implement 112, shown as a bucket, first, at a pin connection 136, and through intermediate links 142, 144 via pin connections 138, 140, 146. Other types of work implements, such as grapples, hydraulic hammers, forks, cutters, and the like, are also well known in the art.

Movement of the various components of the linkage 106 may be achieved by hydraulic actuators 126, 128, 130. For example, boom lift cylinder 126 may be connected between the body 102 and a portion of the boom at pin connection 148 (an identical arrangement may be disposed on the opposite side of the boom, not shown), and stick cylinder 128 may be connected between the boom 108 and stick 110 via pin connections 150, 152. A tilt cylinder 130 may be connected between the stick and intermediate links 142, 144 at pin connections 146, 154, respectively. The machine includes a hydraulic system including one or more pumps (not shown) that are fluidly connected to the hydraulic actuators 126, 128, 130 through various conduits. By actuating one or more control valves (not shown), flow to the actuators is controlled to cause the actuators 126, 128, 130 to extend and/or retract, thereby controlling lift and extension of the boom 108 and stick 110, and tilt of the implement 112, as is well known in the art.

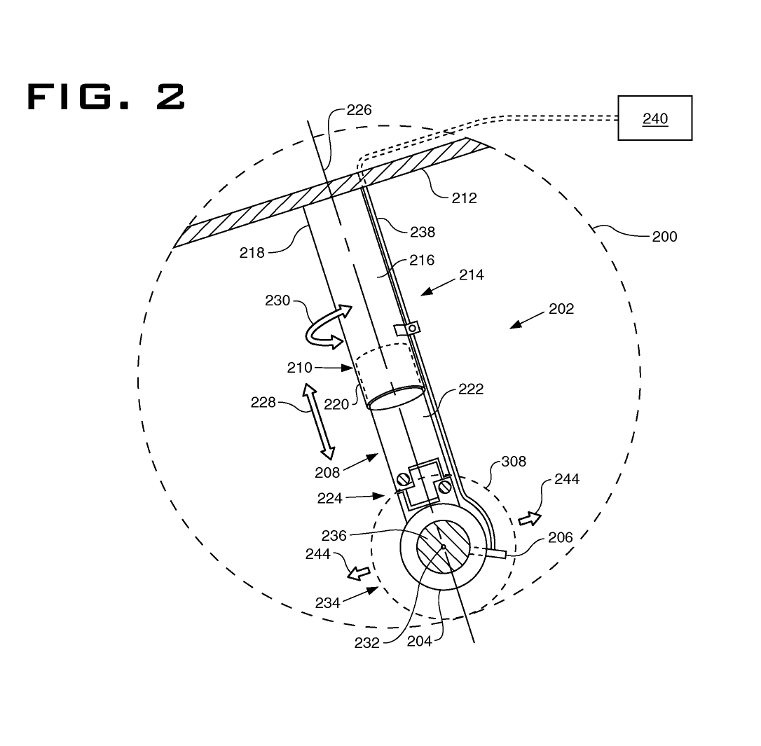

Pin sensors can be associated with any one of the various pin connections described herein to provide a signal indicative of movement and/or position of the pin and its associated components. These signals may be provided to a controller 240 (FIG. 2), either on or off-board, that can be programmed, for example, to determine the position of one or more components of the linkage, the implement, or other machine components associated therewith. The present disclosure specifically relates to mounting assemblies for such sensors.

For example, FIG. 2 is a cross-sectional view of an area designated as 200 in FIG. 1, and sensor assembly 202 associated therewith. The sensor assembly 202 generally consists of a sensor housing 204, sensor 206, and a connector assembly 208 that connects and provides relative movement between the housing 204 and frame element 212. The sensor assembly may generally be mounted within one or more of the linkage 106 elements, such as the boom 108 or stick 110 to protect the sensor 206 and sensor assembly 202 from the typically harsh environment in which such machines 100 operate. An opening and coverplate 156 (FIG. 1) may be provided for access to the sensor assembly 202 for installation and/or service.

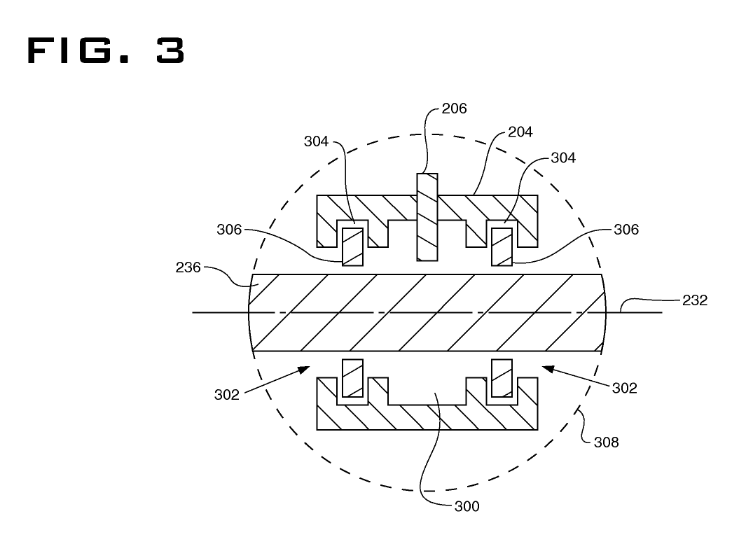

Referring to FIG. 3, the housing 204 may be a metal or hard plastic casing that defines openings 302 at opposing ends thereof, and an internal cavity 300 for receiving pin 236. The housing may include annular grooves 304 adapted to receive annular sealing elements 306 to prevent dust, debris and the like from interfering with or damaging sensor 206.

Sensor 206 may include a potentiometer, including a resistor element and an electroconductive brush moveable together with the pin 236 and held in sliding contact with the resistor element. This device is configured to provide a signal of a voltage represented by the resistance of the resistor element, which varies based on the position of the electroconductive brush. In another embodiment, the sensor 206 may be an optical sensor configured to detect movement of a plurality of circumferentially spaced markings on the pin 206 or an associated sleeve (not shown). In yet another embodiment, the sensor 206 may be a magnetic sensor, such as a hall effect sensor, configured, for example, to detect a plurality of circumferentially spaced elements on the surface of the pin 236 or on a sleeve (not shown) associated therewith. Other types of possible sensors and configurations are well known in the art. As shown in FIGS. 2, 4, 5 and 6, an electrical cable 238 may be attached for providing an electrical connection to a controller 240 and/or providing power for the sensor.

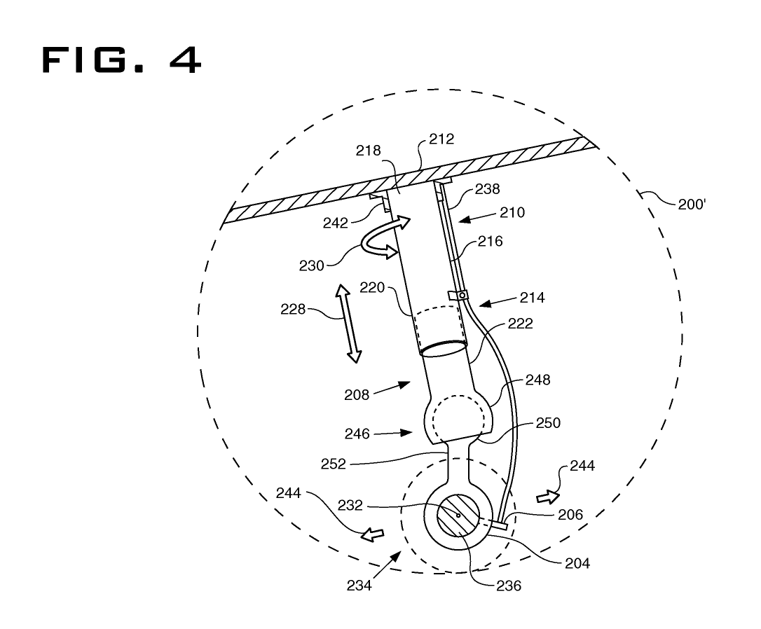

Referring again to FIG. 2, in one embodiment, the connector assembly 208 includes a telescoping portion 214 including a tubular receiving portion 216 having a first end 218 connected to an interior wall, frame element 212 of stick 110. For example, the first end 218 may be welded to the interior wall 212, as shown. In an alternative embodiment, for example, a flange 242 (FIG. 4) may be provided at the first end 218 to facilitate bolting, welding, or otherwise affixing the first end 218 to the interior wall 212. Moreover, while illustrated as being connected to interior wall 212 of stick 110, in other embodiments (not shown), first end 218 may be secured to a cross-member, web, plate, or other structural element associated with the stick 110.

A second end 220 of the receiving portion 216 is configured to receive a cylindrical end 222 of a universal coupling 224. The telescoping portion 214 allows for telescoping movement along a longitudinal axis 226 in the direction of arrows 228, and for rotational movement 230, while the universal coupling 224 provides for movement in one or more directions transverse to axis 226 to accommodate forward/backward 244 movement and side to side tilting movement (of pin axis 232) of the pin 236. The combination of the universal coupling 224 and the telescoping/rotational member 214 allows the attached housing 204 to move to a limited extent with the pin 234 to reduce the effects of slop on the sensor 206.

In another embodiment, shown in FIG. 4, the connector assembly 208 includes a first, telescoping portion 214 that provides telescoping and rotational movement in accordance with directional arrows 228, 230, and also includes a ball and socket coupling 246. The ball and socket coupling 246 may include a receiving portion 248 connected to the cylindrical end 222, and a ball portion 250 having an intermediate member 252 connected to the sensor housing 204.

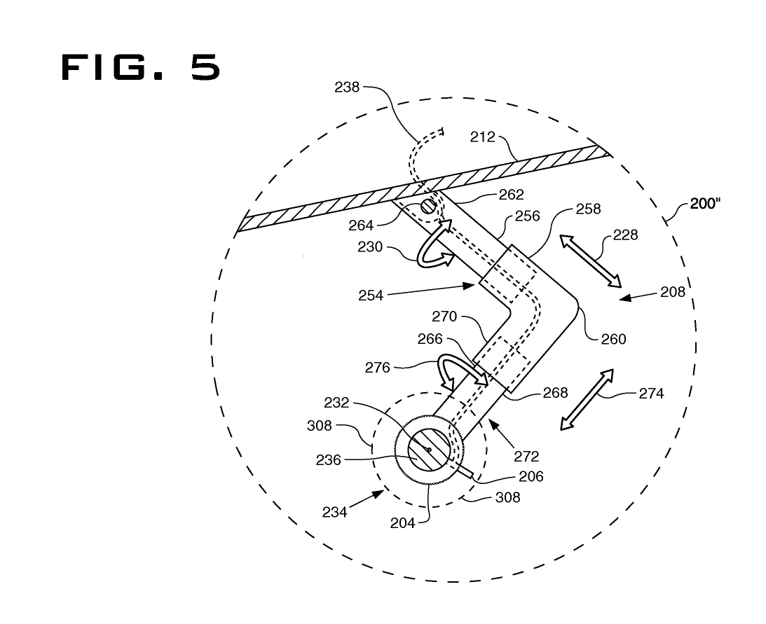

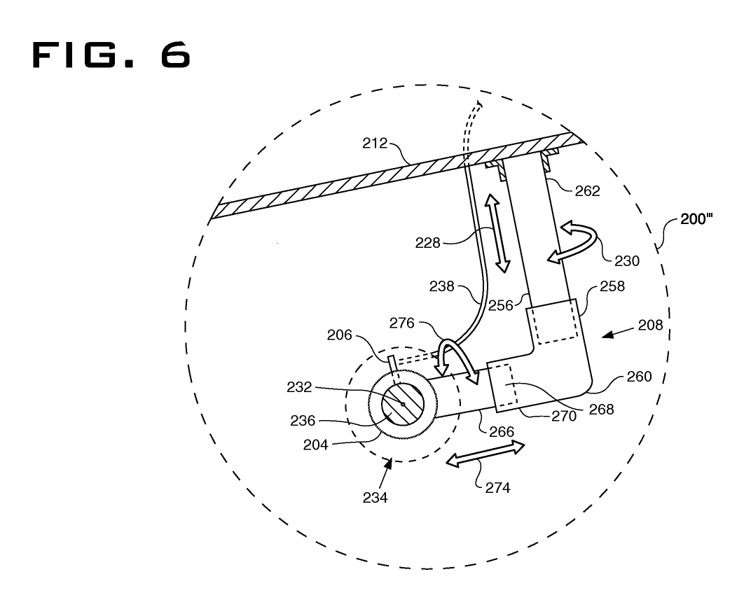

In another embodiment, shown in FIGS. 5-6, the connector assembly 208 may include a first telescoping portion 254 having a cylindrical first member 256 disposed within a first receiving end 258 of an angular section 260. A second end 262 of the first member 256 may be fixedly (FIG. 6), or, pivotally (FIG. 5) connected to the frame element 212, via, for example, a pivotal connection 264.

The sensor housing 204 is connected to a second member 266 having a cylindrical end 268 disposed within a second receiving end 270 of the angled portion 260, constituting a second telescoping portion 272 that provides for telescoping 274 and rotational 276 motion. In the alternative (not shown), one or both ends of angular section 260 may be configured to be received within corresponding tubular ends of members 256 and 266. Moreover, the angular portion 260 is shown having a 90 degree angle to accommodate vertical and horizontal movement of the pin relative to the structural element 212, however, other configurations/angles should be readily appreciated.

### INDUSTRIAL APPLICABILITY

Various machines are known to employ a linkage assembly with a work implement, such as a bucket, shovel, hammer, fork, grapple or cutter, to accomplish the various tasks needed, for example, in the mining, construction, forestry, waste management, oil and gas, and other industries. The linkage typically includes one or more pin connections between the various linkage components that allow for pivoting movement, and one or more actuators, such as hydraulic cylinders, that may be positioned with pin connections at the ends thereof and control movement of the linkage.

It is often desirable to include one or more sensors that are associated with the linkage and/or cylinders to provide an indication of linkage and/or implement position. This may include linear or pressure sensors associated with the linkage, or, as in the embodiments disclosed herein, a sensor associated with the pin to determine a position thereof. The positional information provided can be used, for example, to provide automation or semi-automation of the machine, wherein a controller causes the linkage to follow a desired path by providing output signals to control the hydraulic cylinders based on the determined position of the linkage. Such information may also be used in systems that determine where material has been removed to assist in terrain mapping. Numerous other applications are known to those of skill in the art.

One difficulty with current pin angle sensors is caused by pin slop, wherein, due to manufacturing tolerances or defects, or wear over time, the pin can shift in relation to the bores or openings that connect the pin to the associated linkage components. This can reduce the accuracy of the pin angle sensor in that the pin is rotating relative to the sensor as a result of movement of the pin within the bores or openings, rather than due to actual pivoting movement of the linkage components. To reduce the effects of unintended pin movement or slop on the signal provided by the sensor, the present disclosure provides a moveable connection between the frame element and the sensor housing.

For example, referring again to FIG. 2, as the pin 234 moves within the associated bores of the linkage, the sensor housing 204 and associated sensor 206 will remain relatively stationary relative to the pin 234. Movement of the pin along axis 226 will be accommodated by telescoping member 210, while tilting of pin axis 232 or forward/backward motion 244 will be accommodated by the universal joint 224. Similarly, in the embodiment shown in FIG. 4, the connector assembly 208 provides a telescoping member 210, however, other movements by the pin 234 are mitigated by the ball and socket type connection 246.

In the embodiment shown in FIGS. 5-6, the connector assembly 208 includes a first and second telescoping portion 254, 272 which provide for both linear and rotational movement about the respective telescoping elements. This may be coupled with a pivotal connection 264 at the supporting structural element 212 as demonstrated in FIG. 5. While various types of connections are proposed, and the specific design will vary based on the application, the intent will be to minimize the effects of undesired movement of the pin, and to provide a more accurate indication of pin rotation.

Another problem that is typically encountered with pin sensors is that due the typically harsh environments in which the machines operate, and the position of these sensors on the linkage, dust, debris, fluids, contaminants and other materials will often damage, disable, or otherwise impact operation of the sensor. In the present disclosure, the pin angle sensor has been disposed within a housing 204 with seal elements 306 that prevent dust, debris or other materials from contacting at least a portion of the sensor, thus protecting the sensor and associated elements, and keeping these materials from interfering with operation thereof. Moreover, the sensor assembly has been positioned within an internal cavity 234, as shown in the cross-section of FIGS. 2, 4, 5, and 6. This protects against damage that normally occurs with externally disposed sensors. An access panel 156 may be provided for accessing the cavity 234 for manufacturing and/or service.

It should be understood that the above description is intended for illustrative purposes only. While aspects of the present disclosure have been particularly shown and described with reference to the embodiments above, it will be understood by those skilled in the art that various additional embodiments may be contemplated by modification of the disclosed machines and assemblies without departing from the spirit and scope of what is disclosed. Such embodiments should be understood to fall within the scope of the present invention as determined based upon the claims below and any equivalents thereof.

What is claimed is:

1. A sensor assembly for a pin of a machine linkage, comprising:
a sensor housing having an open end for receiving at least a portion of a pin,
a sensor associated with the housing,
a connector assembly connecting the sensor housing to a frame element, wherein the connector assembly is configured to allow the sensor housing to move relative to the frame element.

2. The sensor assembly of claim 1, wherein the connector assembly includes a telescoping portion having a first member and a second member in telescoping engagement.

3. The sensor assembly of claim 2, wherein the first member and the second member are rotationally coupled.

4. The sensor assembly of claim 2, wherein the first member includes a cylindrical end disposed within a bore of the second member.

5. The sensor assembly of claim 2, wherein the connector assembly includes a universal coupling.

6. The sensor assembly of claim 2, wherein the connector assembly includes a universal coupling disposed between the housing and the telescoping portion.

7. The sensor assembly of claim 2, wherein the connector assembly includes a ball and socket connector.

8. The sensor assembly of claim 7, wherein the ball and socket connector is disposed between the sensor housing and the telescoping portion.

9. The sensor assembly of claim 1, wherein the connector assembly includes an angular portion having a telescoping portion at a first and second end.

10. The sensor assembly of claim 9, wherein in at least one of the telescoping portion also provides for rotational movement.

11. The sensor assembly of claim 1, wherein the sensor housing includes two open ends and a cavity for receiving the pin through the openings.

12. The sensor assembly of claim 11, further including a sealing member disposed adjacent each opening.

13. A machine having a linkage having a plurality of linkage members and a work implement coupled to the linkage at a first end thereof, the linkage including a pin connection having an associated pin sensor assembly, the pin sensor assembly comprising:
a sensor housing having an open end for receiving at least a portion of a pin,
a sensor associated with the housing,
a connector assembly connecting the sensor housing to a portion of one of the linkage members, wherein the connector assembly is configured to allow the sensor housing to move relative to the frame element.

14. The machine of claim 13, wherein one of the linkage members includes an internal cavity, the pin sensor assembly being disposed within the cavity.

15. The machine of claim 14, wherein the pin extends through the sensor housing.

16. The machine of claim 15, wherein the housing includes a first open end and a second open end, and a sealing member disposed at each between the pin and housing.

17. The machine of claim 16, wherein the sealing member is disposed within an annular groove.

18. The machine of claim 13, wherein the connector assembly includes a universal coupling.

19. The machine of claim 13, wherein the connector assembly includes an angular portion having a telescoping portion at a first and a second end.

20. A machine linkage, the machine linkage including a first member and a second member, each member having an end with at least two spaced openings, a pin disposed within the aligned openings of the first and second member, the first member including an internal cavity, a pin sensor assembly disposed within the internal cavity, the sensor assembly comprising:
a housing having a first and second open end, the pin disposed through the first and second open ends, the housing disposed between the spaced openings of the first and second member;
a sensor associated with the housing and configured to provide a signal indicative of rotation of the pin;
a connector assembly connecting the sensor housing to the first member, wherein the connector assembly is configured to allow the sensor housing to move relative to the first member.

21. The machine linkage of claim 20, wherein the connector assembly includes an angular portion having a telescoping portion at a first and second end, the first telescoping portion having a first member connected to the housing and a second member connected to the first member, at least one of the two telescoping portions also providing for rotational movement.

22. The machine linkage of claim 20, wherein the telescoping portions are disposed at a 90 degree angle.
